(19) United States
(12) Patent Application Publication
(10) Pub. No.: US 2026/0352757 A1
(43) Pub. Date: Nov. 5, 2026

(54) MOBILE DEVICE WITH USER INTERFACE FOR DUAL SIM APPLICATIONS

(71) Applicant: Sony Group Corporation, Tokyo (JP)

(72) Inventors: Kenji KIMURA, Tokyo (JP); Takeshi TANIGAWA, Tokyo (JP); Shuto NAGAMATSU, Tokyo (JP)

(73) Assignee: Sony Group Corporation, Tokyo (JP)

(21) Appl. No.: 19/158,909

(22) PCT Filed: Mar. 8, 2024
(86) PCT No.: PCT/JP2024/008976

§ 371 Date: Aug. 22, 2025

(30) Foreign Application Priority Data
Mar. 24, 2023 (JP) 2023-048676

(51) Int. Cl. H04M 1/72403; H04M 1/72469; H04W 88/06

(52) U.S. Cl. CPC H04M 1/72403; H04M 1/72469; H04M 2201/42; H04M 2250/22; H04W 88/06

(57) ABSTRACT

A communication apparatus includes circuitry configured to perform first radio communication using first profile data of a first Subscriber Identify Module (SIM), and perform second radio communication using second profile data of a second SIM, cause a screen of the communication apparatus to display a first indicator of a communication state of the first radio communication under an operational condition in which the first radio communication is active, and cause the screen to display a second indicator of a communication state of the second radio communication under another condition that the second radio communication is active.

### TECHNICAL FIELD

The present disclosure relates to a communication apparatus, an information processing method, and a non-transitory computer readable memory.

### BACKGROUND ART

A communication apparatus capable of using a plurality of wireless communication schemes is known. For example, a dual Subscriber Identity Module (SIM) dual active (DSDA) compatible terminal apparatus that includes two subscriber identity modules (SIMs) and is capable of simultaneously performing voice and data communications using a mobile network is known.

### CITATION LIST

### Patent Literature

PTL 1: JP 2021-150944 A

### SUMMARY OF INVENTION

### Technical Problem

A communication apparatus capable of using a plurality of wireless communications may cause inconvenience to a user regarding simultaneous use of a plurality of wireless communications. For example, in the case of a communication apparatus (for example, a terminal apparatus compatible with DSDA) capable of using a plurality of wireless communications of the same type, although the user can know which type of wireless communications (for example, a mobile network rather than a wireless LAN) are used, it is difficult for the user to know how the type of wireless communications are used in detail. For example, although the user can know that the mobile network is used, it is difficult for the user to know whether only one SIM is used or a plurality of SIMs is used.

In particular, a current DSDA-compatible terminal apparatus is designed on the assumption that a user makes a call and performs data communications at the same time. It is not assumed that the terminal apparatus performs data communications by simultaneously using two SIMs. In the future, it is assumed that the DSDA-compatible terminal apparatus can perform data communications using two SIMs simultaneously. Even if the terminal apparatus performs data communications by using the two SIMs simultaneously, the user cannot know that in the conventional technology. In this case, the user does not know in detail how the wireless communications are used, and is forced to have inconvenience.

Therefore, the present disclosure proposes a communication apparatus, an information processing method, and a program with high convenience.

### Solution to Problem

A communication apparatus includes circuitry configured to perform first radio communication using first profile data of a first Subscriber Identify Module (SIM), and perform second radio communication using second profile data of a second SIM, cause a screen of the communication apparatus to display a first indicator of a communication state of the first radio communication under an operational condition in which the first radio communication is active, and cause the screen to display a second indicator of a communication state of the second radio communication under another condition that the second radio communication is active.

### BRIEF DESCRIPTION OF DRAWINGS

FIG. 1 is a view for describing an outline of a solution, according to an embodiment, that addresses the above identified and other issues associated with conventional devices and methods.

FIG. 2 is a diagram illustrating a configuration example of a communication system according to an embodiment of the present disclosure.

FIG. 3 is a diagram illustrating a configuration example of a server according to an embodiment of the present disclosure.

FIG. 4 is a diagram illustrating a configuration of a terminal apparatus according to the present embodiment.

FIG. 5 is a view illustrating an example of an appearance of the terminal apparatus.

FIG. 6 is a diagram illustrating an example of an RSP architecture configuration applied to a communication system 1 according to the present embodiment.

FIG. 7 is a diagram illustrating a first display example according to Example 1.

FIG. 8 is a diagram illustrating a second display example according to Example 1.

FIG. 9 is a diagram illustrating a third display example according to Example 1.

FIG. 10 is a diagram illustrating a fourth display example according to Example 1.

FIG. 11 is a diagram illustrating the first display example according to Example 2.

FIG. 12 is a diagram illustrating the second display example according to Example 2.

FIG. 13 is a diagram illustrating the first display example according to Example 3.

FIG. 14 is a diagram illustrating the second display example according to Example 3.

FIG. 15 is a diagram illustrating the third display example according to Example 3.

FIG. 16 is a diagram illustrating the first display example according to Example 4.

FIG. 17 is a diagram illustrating the second display example according to Example 4.

### DESCRIPTION OF EMBODIMENTS

Hereinafter, embodiments of the present disclosure will be described in detail with reference to the drawings. In each of the following embodiments, the same parts are denoted by the same reference numerals, and redundant description will be omitted.

### <<1. Outline of Present Embodiment>>

Before describing the present embodiment in detail, an outline of the present embodiment will be described.

### <1-1. Problem>

A communication apparatus capable of using a plurality of wireless communications is known. For example, a dual SIM dual active (DSDA) compatible terminal apparatus that includes two subscriber identity modules (SIMs) and is capable of simultaneously performing call and data communications using a mobile network is known.

As recognized by the present inventor, a communication apparatus capable of using a plurality of wireless communications may cause inconvenience to a user regarding simultaneous use of a plurality of wireless communications. For example, in the case of a communication apparatus (for example, a terminal apparatus compatible with DSDA) capable of using a plurality of wireless communication schemes of a same type, even though the user can know which type of wireless communications (for example, a mobile network rather than a wireless LAN) are used, it is difficult for the user to know specifically which variant of wireless communications are used. For example, although the user can know that the mobile network is used, it is difficult for the user to know whether only one SIM is used or a plurality of SIMs is used.

In particular, a current DSDA-compatible terminal apparatus is designed on the assumption that a user makes a call and performs data communications at the same time. It is not assumed that the terminal apparatus performs data communications by simultaneously using two SIMs. In the future, it is assumed that the DSDA-compatible terminal apparatus can perform data communications using two SIMs simultaneously. However, as recognized by the present inventor, even if the terminal apparatus performs data communications by using the two SIMs simultaneously, the user has no way of being informed of that fact in the conventional technology. In this case, the user does not know in detail how the wireless communications are used, which is not only inconvenient for the user, but may cause the user to accidently use the wrong SIM under the user's intended circumstance.

Therefore, the present embodiment solves the above-identified, and other, problems as follows.

### <1-2. Solution>

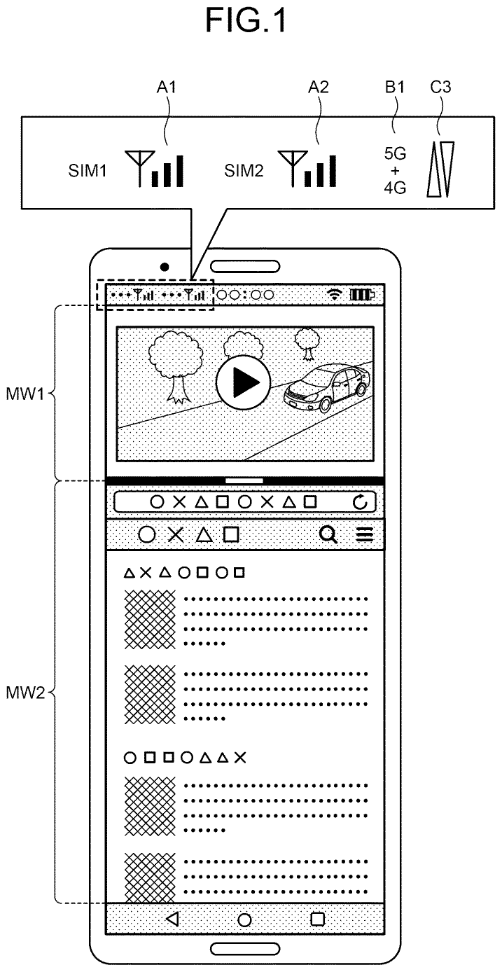

FIG. 1 is a diagram for describing an outline of a solution according to the present embodiment.

The communication apparatus of the present embodiment is, for example, a terminal apparatus possessed by a user. In the example of FIG. 1, the terminal apparatus is a smart device (smartphone or tablet).

The terminal apparatus of the present embodiment includes a display unit (“a display” such as OLED or the like that may include an integrated touch interface, and/or cooperates with a separate interface such as a touchpanel or keypad). In the example of FIG. 1, the terminal apparatus includes a touch panel display as a display unit. Note that, in the example of FIG. 1, the display unit is in a display state having a multi-window that is divided into two parts, an upper and a lower part. Specifically, a window MW1 is provided on the upper side of the display unit, and a window MW2 is provided on the lower side. Different applications are displayed in these windows. In the following description, the application displayed in the window MW1 may be referred to as a first application, and the application displayed in the window MW2 may be referred to as a second application.

The display unit of the terminal apparatus may also be provided with another area for displaying general information (for example, time, radio field intensity, battery state, and the like). In the example of FIG. 1, a horizontally long rectangular area on which pictures (e.g., icons) of an antenna, a battery, and the like are displayed on the upper part of the display unit corresponds to the another area. In the following description, this area may be referred to as a status bar. In the example of FIG. 1, at least a radio field intensity indication A1 and a radio field intensity indication A2 are displayed on the status bar. The radio field intensity indication A1 is a radio field intensity indication of a SIM 1, and the radio field intensity indication A2 is a radio field intensity indication of a SIM 2.

The terminal apparatus of the present embodiment is, for example, a Dual SIM Dual Active (DSDA) compatible terminal apparatus including a plurality of Subscriber Identity Modules (SIMs). At this time, any SIM included in the terminal apparatus may be a SIM card (SIM profile data recorded in the SIM card) or an eSIM (eSIM profile data). In the following description, one of the plurality of SIMs included in the terminal apparatus may be referred to as a first SIM, and the another SIM may be referred to as a second SIM. In the example of FIG. 1, the first SIM is the SIM 1, and the second SIM is the SIM 2.

The terminal apparatus according to the present embodiment can execute communications that simultaneously uses a plurality of data communications including first data communication using a first profile associated with the first SIM and second data communication using a second profile associated with the second SIM (hereinafter, referred to as simultaneous communications). For example, the terminal apparatus can perform simultaneous communications in which the data communication of the first application is the first data communication using the first profile, and the data communication of the second application is the second data communication using the second profile. Note that the simultaneous communications may be data communications of one or a plurality of applications performed using a plurality of data communications (for example, the first data communication and the second data communication).

Then, the terminal apparatus displays an indication related to the simultaneous communications on the display unit. For example, the terminal apparatus displays, on the display unit, an indication that makes it possible to distinguish whether simultaneous communications are being executed or communications using any of a plurality of data communications (hereinafter, also referred to as non-simultaneous communications or individual communications) are being executed as the indication related to the simultaneous communications.

For example, the terminal apparatus displays the indication related to the simultaneous communications in association with the indication related to the first data communication (for example, radio field intensity indication A1) and the indication related to the second data communication (for example, radio field intensity indication A2). For example, as illustrated in FIG. 1, when performing simultaneous communications, the terminal apparatus displays, on the status bar, a communication icon B1 indicating that simultaneous communications are being performed together with the radio field intensity indication A1 and the radio field intensity indication A2. When performing data communications of one application by using both the first data communication and the second data communication, the terminal apparatus may display a communication icon C3 indicating a current communication direction (downloading/uploading) of simultaneous communications on the status bar.

As a result, even in a case where the terminal apparatus simultaneously uses a plurality of wireless communications of the same type, the user can know in detail how the wireless communications are used. As a result, convenience of the terminal apparatus is improved.

The outline of the present embodiment has been described above, and a terminal apparatus 20 according to the present embodiment will be described in detail below.

### <<2. Configuration of Communication System>>

First, a configuration of the communication system 1 will be described.

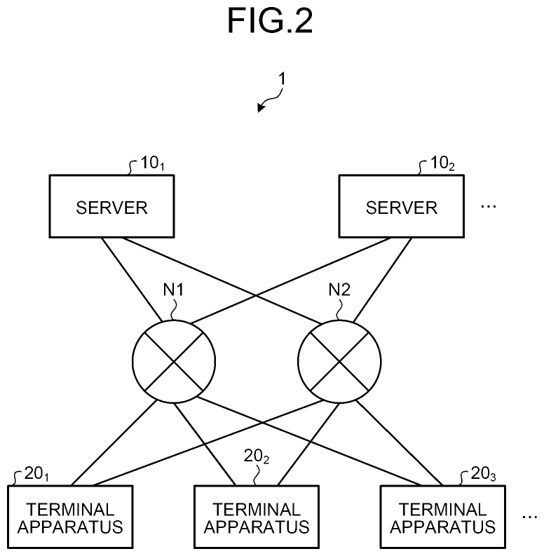

FIG. 2 is a diagram illustrating a configuration example of a communication system 1 according to an embodiment of the present disclosure. The communication system 1 includes a server 10 and a terminal apparatus 20 configured to be connectable to a plurality of communication paths. The communication system 1 may include a plurality of servers 10 and a plurality of terminal apparatuses 20. In the example of FIG. 2, the communication system 1 includes servers 10₁, 10₂, and the like as the server 10, and includes terminal apparatuses 20₁, 20₂, 20₃, and the like as the terminal apparatus 20. The terminal apparatuses 20 connect the servers 10 via the network N1 and/or the network N2.

The networks N1 and N2 are, for example, cellular networks of different mobile network operators (MNOs). The networks N1 and N2 may be cellular networks of the same MNO. Note that the networks N1 and N2 are not limited to cellular networks. For example, the networks N1 and N2 may be a communication network other than a cellular network, such as a local area network (LAN), a wide area network (WAN), a fixed telephone network, a regional Internet protocol (IP) network, or the Internet. The networks N1 and N2 may include a wired network or a wireless network. In addition, the networks N1 and N2 may include a core network. The core network is, for example, an evolved packet core (EPC) or a 5G core network (5GC). Typically, the network N may be a data network connected to the core network. The data network may be a service network of a telecommunications carrier, for example, an IP Multimedia Subsystem (IMS) network. Furthermore, the data network may be a private network such as an intra-company network.

Note that, in the example of FIG. 2, only two networks, the network N1 and the network N2, are illustrated as the networks used by the terminal apparatus 20, but the number of networks is not limited to two. There may be three or more networks. Furthermore, the network may be any one of the network N1 and the network N2.

The terminal apparatus 20 of the present embodiment can be connected to a network using a plurality of communication paths. At this time, at least one of the plurality of communication paths may be a wireless communication path. For example, the communication path may be a wireless communication path (wireless access network) between the terminal apparatus 20 and the base station. Furthermore, the communication path may be a wireless communication path between the terminal apparatus 20 and an access point. Needless to say, the plurality of communication paths may include a wired communication path (for example, a wired LAN). Note that the communication path may be a network itself.

In a case where a wireless communication path is included in the plurality of communication paths, the terminal apparatus 20 may be configured to connect to a network using a radio access technology (RAT) such as long term evolution (LTE), new radio (NR), 6G, Wi-Fi, or Bluetooth (registered trademark). At this time, the terminal apparatus 20 may be configured to be able to use different radio access technologies (wireless communications schemes). For example, the terminal apparatus 20 may be configured to be able to use NR and Wi-Fi. Furthermore, the terminal apparatus 20 may be configured to be able to use different cellular communications technologies (for example, LTE, NR, or 6G). LTE and NR are a type of cellular communications technology, and enable mobile communications of a terminal apparatus by arranging a plurality of areas covered by a base station in a cell shape. In addition, 6G is also a type of cellular communications technology, and enable mobile communications of a terminal apparatus by arranging a plurality of areas covered by a base station in a cell shape.

Note that, in the following description, “LTE” includes LTE-Advanced (LTE-A), LTE-Advanced Pro (LTE-A Pro), and Evolved Universal Terrestrial Radio Access (EUTRA). In addition, NR includes New Radio Access Technology (NRAT) and Further EUTRA (FEUTRA). Note that a single base station may manage a plurality of cells. In the following description, a cell corresponding to LTE is referred to as an LTE cell, and a cell corresponding to NR is referred to as an NR cell.

NR is a radio access technology of a next generation (fifth generation) of Long Term Evolution (fourth generation communications including LTE-Advanced and LTE-Advanced Pro). NR is a radio access technology that can support various use cases including Enhanced Mobile Broadband (eMBB), Massive Machine Type Communications (mMTC), and Ultra-Reliable and Low Latency Communications (URLLC). NR has been studied aiming at a technical framework corresponding to usage scenarios, requirement conditions, arrangement scenarios, and the like in these use cases.

6G is a cellular communications technology of a next generation of NR or 5G system (5GS) which is fifth generation mobile communications, and includes a radio access technology and a network technology between a base station, a core network, and a data network. In 6G, there may be included new technologies in advanced (extreme connectivity) and new aspects of each of eMBB, mMTC, and URLLC, which have been considered as main use cases or required conditions in NR. As the new technology, for example, AI (Cognitive network, AI native Air Interface), sensing (including Rader sensing, network as a sensor), terahertz communications, and the like are assumed.

Note that the terminal apparatus 20 may be connectable to a network using a radio access technology (wireless communications scheme) other than LTE, NR, 6G, Wi-Fi, and Bluetooth. For example, the terminal apparatus 20 may be connectable to a network by using low power wide area (LPWA) communications. Furthermore, the terminal apparatus 20 may be connectable to a network by using wireless communications of original standards.

Here, the LPWA communications are wireless communications that enable low-power wide-range communications. For example, the LPWA radio is Internet of Things (IoT) wireless communications using a specified low power radio (for example, a 920 MHz band) or an industrial-science-medical (ISM) band. Note that the LPWA communications used by the terminal apparatus 20 may conform to the LPWA standards. Examples of the LPWA standards include ELTRES, ZETA, SIGFOX, LoRaWAN, NB-Iot, and the like. Generally, the LPWA standards are not limited thereto, and may be other LPWA standards.

Note that the plurality of communication paths may include a virtual network. For example, the plurality of communication paths to which the terminal apparatus 20 can be connected may include a virtual network such as a virtual local area network (VLAN) and a physical network such as an IP communication path. In this case, the terminal apparatus 20 may perform the route control based on a route control protocol such as Open Shortest Path First (OSPF) or Border Gateway Protocol (BGP).

In addition, the plurality of communication paths may include one or a plurality of overlay networks or one or a plurality of network slicing.

Note that the devices in the drawings may be considered as devices in a logical sense. That is, a part or all of the devices in the drawing may be realized by a virtual machine (VM), a container, a docker, or the like, and they may be implemented on physically the same hardware.

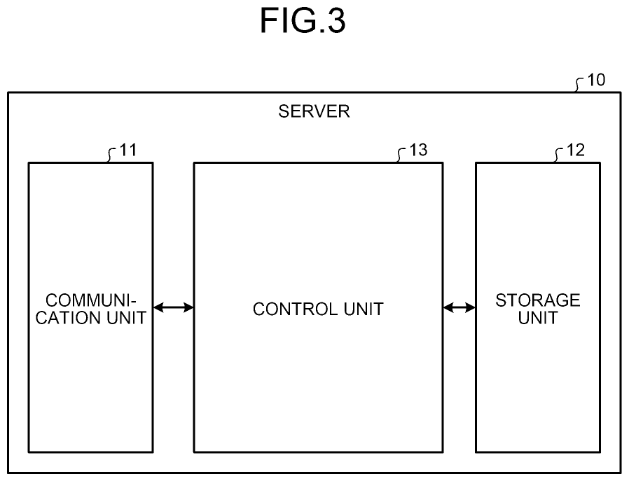

Furthermore, in the present embodiment, the communication apparatus is a device having a communication function, and at least the terminal apparatus 20 is a communication apparatus in the example of FIG. 3. The server 10 may be regarded as a communication apparatus.

Hereinafter, a configuration of each device constituting the communication system 1 will be specifically described. Note that the configuration of each device described below is merely an example. The configuration of each device may be different from the following configuration.

### <2-1. Configuration of Server>

First, a configuration of the server 10 will be described.

The server 10 is an information processing apparatus (computer) that provides various services to the terminal apparatus 20 via an upstream network (for example, networks N1 and N2). For example, the server 10 is an application server or a Web server. The server 10 may be a PC server, a mid-range server, or a main frame server. In addition, the server 10 may be an information processing apparatus that performs data processing (edge processing) near a user or a terminal. For example, the server 10 may be an information processing apparatus (computer) attached to or built in the base station. Needless to say, the server 10 may be an information processing apparatus that performs cloud computing.

FIG. 3 is a diagram illustrating a configuration example of the server 10 according to an embodiment of the present disclosure. The server 10 includes a communication unit 11, a storage unit 12, and a control unit 13. Note that the configuration illustrated in FIG. 3 is a functional configuration, and the hardware configuration may be different from the functional configuration. Furthermore, the functions of the server 10 may be implemented in a distributed manner in a plurality of physically separated configurations. For example, the server 10 may include a plurality of information processing apparatuses.

The communication unit 11 is a communication interface for communicating with other devices. For example, the communication unit 11 is a network interface. For example, the communication unit 11 is a local area network (LAN) interface such as a network interface card (NIC). Note that the communication unit 11 may be a wired interface or a wireless interface. The communication unit 11 communicates with the terminal apparatus 20 under the control of the control unit 13.

The storage unit 12 is one or more data readable/writable storage device(s) such as a dynamic random access memory (DRAM), a static random access memory (SRAM), a flash memory, or a hard disk.

The control unit 13 is a controller (which is a programmable controller that is configured via the execution of computer readable instructions) that controls each unit of the server 10. The control unit 13 is realized by, for example, a processor such as a central processing unit (CPU) or a micro processing unit (MPU). For example, the control unit 13 is implemented by a processor executing various programs stored in a storage device inside the server 10 using a random access memory (RAM) or the like as a work area. As discussed above, the control unit 13 may be realized by an integrated circuit such as an application specific integrated circuit (ASIC) or a field programmable gate array (FPGA). Any of the CPU, the MPU, the ASIC, and the FPGA can be regarded as a controller.

### <2-2. Configuration of Terminal Apparatus>

The terminal apparatus 20 is an information processing apparatus (computer) possessed by the user. For example, the terminal apparatus 20 is a wireless communication apparatus that performs wireless communications with another wireless communication apparatus (for example, a base station, a relay station, another terminal apparatus 20, or the like).

The terminal apparatus 20 is configured to be connectable to a plurality of communication paths. For example, the terminal apparatus 20 may be configured to be remotely connectable via two communication paths, Wi-Fi (registered trademark) and a cellular network. The terminal apparatus 20 may be connectable to a plurality of cellular networks. At this time, the plurality of cellular networks may be associated with different subscriber identity modules (SIMs).

As the terminal apparatus 20, any form of information processing apparatus (computer) can be employed. For example, the terminal apparatus 20 may be a mobile terminal such as a mobile phone, a smart device (smartphone or tablet), a personal digital assistant (PDA), or a notebook PC. Furthermore, the terminal apparatus 20 may be an imaging apparatus having communication functions (for example, a camcorder). Furthermore, the terminal apparatus 20 may be a motorcycle, a moving relay vehicle, or the like on which a communication device such as a field pickup unit (FPU) is mounted. Furthermore, the terminal apparatus 20 may be a Machine to Machine (M2M) device or an Internet of Things (IoT) device. Furthermore, the terminal apparatus 20 may be a wearable device such as a smart watch.

Furthermore, the terminal apparatus 20 may be an xR device such as an augmented reality (AR) device, a virtual reality (VR) device, or a mixed reality (MR) device. At this time, the xR device may be a glasses-type device such as AR glasses or MR glasses, or may be a head-mounted device such as a VR head-mounted display. In a case where the terminal apparatus 20 is assumed as an xR device, the terminal apparatus 20 may be a standalone device including only a user wearing portion (for example, the eyeglass portion). Furthermore, the terminal apparatus 20 may be a terminal interlocking device including a user wearing portion (for example, the eyeglass portion) and a terminal portion (for example, a smart device) interlocked with each other.

Note that the terminal apparatus 20 may be configured to be able to use a SIM card by switching a plurality of SIM cards. For example, the terminal apparatus 20 may be compatible with dual SIM or triple SIM. Generally, the terminal apparatus 20 may be configured so that more than three SIM cards can be inserted into the terminal apparatus 20, or at least one of the three or more SIMs may be an eSIM.

Furthermore, the terminal apparatus 20 may be compatible with a remote SIM provisioning (RSP). For example, the terminal apparatus 20 may be compatible with embedded SIM (eSIM). The RSP-compatible terminal apparatus can rewrite information related to wireless communications (hereinafter, referred to as a profile) without replacing the SIM card.

Here, the profile is information related to wireless communications, and is data in which information of a service provider (communications carrier) and contractor information (for example, ICCID assigned to eSIM, etc.) are recorded. An IC card identifier (ICCID) is a unique number for identifying the profile. The profile can be downloaded from a server on the network (for example, the server 10).

The profile may be an eSIM profile. The eSIM profile is a profile used in an eSIM-compatible communication apparatus. For example, an eSIM profile is a combination of data and applications provisioned on an eUICC for the purpose of providing a service. An embedded UICC (eUICC) is a universal integrated circuit card (UICC) that enables local management of profiles in a secure manner. In the following description, not only the profile recorded in the SIM card but also the eSIM profile may be referred to as a SIM profile or simply a profile.

The terminal apparatus 20 may be able to perform non-orthogonal multiple access (NOMA) communications with the base station. The terminal apparatus 20 may be able to use an automatic retransmission technology such as hybrid automatic repeat request (HARQ) when communicating with the base station. The terminal apparatus 20 may be able to perform sidelink communications with another terminal apparatus 20. The terminal apparatus 20 may be able to use an automatic retransmission technology such as HARQ when performing sidelink communications. The terminal apparatus 20 may be able to perform NOMA communications when performing sidelink communications with another terminal apparatus 20. The terminal apparatus 20 may be able to perform LPWA communication with another wireless communication apparatus such as a base station. The wireless communications used by the terminal apparatus 20 may be wireless communications using millimeter waves. The wireless communications used by the terminal apparatus 20 may be wireless communications using radio waves including sidelink communications, or may be wireless communication using infrared rays or visible light, that is, optical radio.

The terminal apparatus 20 may be a movable wireless communication apparatus, that is, a mobile device. The terminal apparatus 20 may be a wireless communication apparatus installed in a mobile body or may be a mobile body itself. The terminal apparatus 20 may be a vehicle that moves on a road, such as an automobile, a bus, a truck, or a motorcycle, or may be a wireless communication apparatus mounted on the vehicle. The mobile body may be a mobile terminal, or may be a mobile body that moves on land (on the ground in a narrow sense), in the ground, on water, or under water. Furthermore, the mobile body may be a mobile body that moves in the atmosphere, such as an aircraft, an airship, a balloon, or a helicopter, or may be a mobile body that moves outside the atmosphere, such as an artificial satellite. The mobile body may be an unmanned aerial vehicle (UAV) such as a drone. Furthermore, the terminal apparatus 20 may be a wireless communication apparatus mounted on the mobile body.

The terminal apparatus 20 may be able to communicate by being connected to a plurality of base stations or a plurality of cells at the same time. In a case where one base station supports a communication area via a plurality of cells (for example, pCell or sCell), the plurality of cells can be bundled to communicate between the base station and the terminal apparatus 20 by a carrier aggregation (CA) technology, a dual connectivity (DC) technology, a multi-connectivity (MC) technology, or the like. Alternatively, the terminal apparatus 20 and the plurality of base stations may communicate with each other by a Coordinated Multi-Point Transmission and Reception (COMP) technology through cells of different base stations.

The terminal apparatus 20 may be a relay terminal that relays communications to a remote terminal.

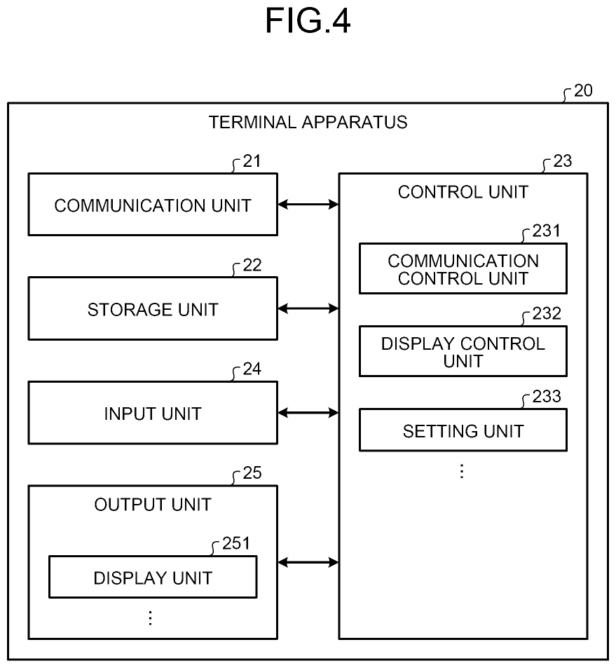

FIG. 4 is a diagram illustrating a configuration of the terminal apparatus 20 according to the present embodiment. The terminal apparatus 20 includes a communication unit 21, a storage unit 22, a control unit 23, an input unit 24, and an output unit 25. However, the configuration illustrated in FIG. 4 is a functional configuration, and the hardware configuration may be different from the functional configuration. Furthermore, the functions of the terminal apparatus 20 may be implemented in a distributed manner in a plurality of physically separated configurations. As with the discussion provided above, the term “unit” is a term of convenience to refer to circuitry (programmable and hardwired, as well as any associated structures such as a housing, PCB, and the like).

The communication unit 21 is a communication interface for communicating with other devices. For example, the communication unit 11 is a local area network (LAN) interface such as a network interface card (NIC). The communication unit 21 may be a wired interface or a wireless interface.

In a case where the communication unit 21 includes a wireless interface, the communication unit 21 may be configured to connect to a network or another communication apparatus using a radio access technology (RAT) such as long term evolution (LTE), new radio (NR), Wi-Fi, or Bluetooth (registered trademark). At this time, the communication unit 21 may be configured to be able to use different radio access technologies. For example, the communication unit 21 may be configured to be able to use NR and Wi-Fi. Furthermore, the communication unit 21 may be configured to be able to use different cellular communication technologies (for example, LTE and NR, or NR and 6G). In addition, the communication unit 21 may be connectable to a network or another communication apparatus using a radio access technology other than LTE, NR, 6G, Wi-Fi, and Bluetooth.

Note that the communication unit 21 may be a signal processing unit for wireless communications with another wireless communication apparatus (for example, a base station, a relay station, or another terminal apparatus 20). In this case, the communication unit 21 may support one or a plurality of radio access schemes. The communication unit 21 may correspond to at least one of NR, LTE, and 6G. The communication unit 21 may support W-CDMA, cdma 2000, and the like in addition to NR, LTE, and 6G. The communication unit 21 may support an automatic retransmission technology such as hybrid automatic repeat request (HARQ).

The communication unit 21 includes, for example, a transmission processing unit (e.g., transmitter), a reception processing unit (receiver), and an antenna. In a case where the communication unit 21 supports a plurality of radio access schemes, each unit constituting the communication unit 21 may be individually configured for each radio access scheme. The transmission processing unit and the reception processing unit may be individually configured for LTE, NR, and 6G. The antenna may be configured by a plurality of antenna elements, for example, a plurality of patch antennas. The communication unit 21 may have a beamforming function. For example, the communication unit 21 may have a polarization beamforming function using vertically polarized waves (V-polarized waves) and horizontally polarized waves (H-polarized waves) (or a polarization beamforming function using dual polarization in polarization directions of 45 degrees and −45 degrees from the vertical direction). Furthermore, the communication unit 21 may have a point forming function.

The storage unit 22 is a readable/writable storage device such as a DRAM, an SRAM, a flash memory, or a hard disk. The storage unit 22 functions as a storage unit of the terminal apparatus 20.

The control unit 23 is a controller that controls each unit of the terminal apparatus 20. The control unit 23 controls a wireless communication unit to perform wireless communications with another wireless communication apparatus (for example, a base station, a relay station, or another terminal apparatus 20). The control unit 23 may be realized by a processor such as a CPU or an MPU. Specifically, the control unit 23 may be implemented by a processor executing various programs stored in a storage device inside the terminal apparatus 20 using a RAM or the like as a work area. The control unit 23 may be realized by an integrated circuit such as an ASIC or an FPGA. Any of the CPU, the MPU, the ASIC, and the FPGA can be regarded as a controller. The control unit 23 may be realized by a GPU. Any of the CPU, the MPU, the ASIC, the FPGA, and the GPU can be regarded as a controller. Note that the control unit 23 may include a plurality of physically separated objects. For example, the control unit 23 may include a plurality of semiconductor chips.

The control unit 23 includes a communication control unit 231, a display control unit 232, and a setting unit 233. Each block (communication control unit 231 to setting unit 233) constituting the control unit 23 is a functional block indicating a function of the control unit 23. These functional blocks may be software blocks or hardware blocks. For example, each of the functional blocks described above may be one software module realized by software (including micro programs), or may be one circuit block on a semiconductor chip (die). Generally, each functional block may be one processor or one integrated circuit. The control unit 23 may be configured by a functional unit different from the above-described functional blocks. A configuration method of the functional blocks is arbitrary.

The input unit 24 is an input device (interface) that receives various inputs externally. For example, the input unit 24 is an operation device for the user to perform various operations, such as a keyboard, a mouse, and operation keys. Note that, in a case where a touch panel is adopted as the terminal apparatus 20, the touch panel is also included in the input unit 24. In this case, the user performs various operations by touching the screen with a finger or a stylus.

The output unit 25 is a device that performs various outputs such as sound, light, vibration, and an image externally. The output unit 25 performs various outputs to the user under the control of the control unit 23. Note that the output unit 25 includes a display device that displays various types of information. The display device is, for example, a liquid crystal display or an organic electro luminescence (EL) display. In the following description, a display device included in the terminal apparatus 20 or a screen formed by the display device of the terminal apparatus 20 may be referred to as a display unit 251. Note that the display unit 251 may be a touch panel type display device. In this case, the display unit 251 may be regarded as a configuration integrated with the input unit 24.

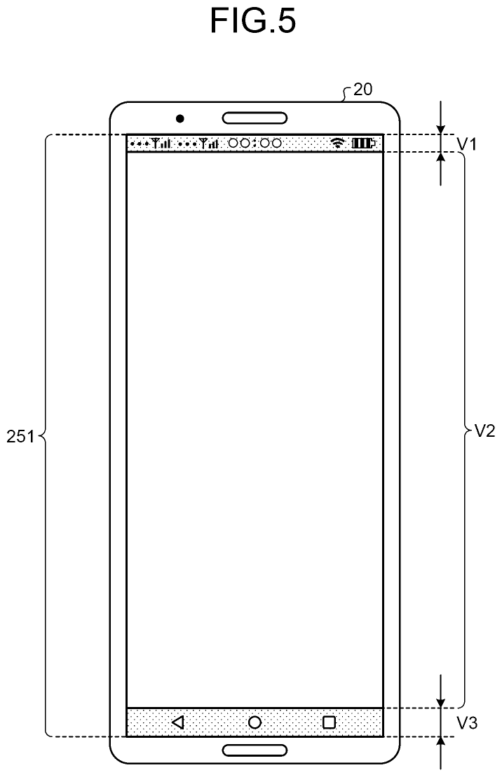

FIG. 5 is a view illustrating an example of an appearance of the terminal apparatus 20. The display unit 251 may be, for example, a vertically long screen as illustrated in FIG. 5. An upper area V1 of the display unit 251 is an area for displaying general information (for example, time, radio field state, battery state, and the like). A lower area V3 of the display unit 251 is an area for displaying various keys (for example, a back key, a home key, and a menu/multitasking key.). A central area V2 sandwiched between these areas is a display area of the application screen. Note that the display area of the application screen is not limited to the central area V2. For example, the terminal apparatus 20 may set an area obtained by combining the upper area V1 and/or the lower area V3 with the central area V2 as the display area of the application screen.

Note that, in a case where the terminal apparatus 20 is an xR device (for example, AR/MR glasses), the output unit 25 may be a transmission type device that projects an image on a glass, or may be a retina projection type device that directly projects an image on the retina of the user. Note that there may be a case where the terminal apparatus 20 does not have a screen as an object (for example, a screen projected on a display, a panel, or the like), for example, by having a means for directly projecting an image on the retina of the user. Even in this case, if the user can recognize the screen, the screen can be regarded as the display unit 251 of the present embodiment.

Note that, in a case where the terminal apparatus 20 is an xR device, the terminal apparatus 20 may detect an operation in which the user is going to touch the screen on the basis of information from a sensor that detects a motion of a hand of the user. In this case, the following embodiment may be applied by regarding an operation in which the user is going to touch the screen as a touch operation. In the following description, the display unit 251 included in the terminal apparatus 20 is assumed to be a touch panel display as an example.

### <2-3. RSP Architecture>

The terminal apparatus 20 may be compatible a remote SIM provisioning (RSP). For example, the terminal apparatus 20 may be compatible with embedded SIM (eSIM). Hereinafter, the RSP will be described.

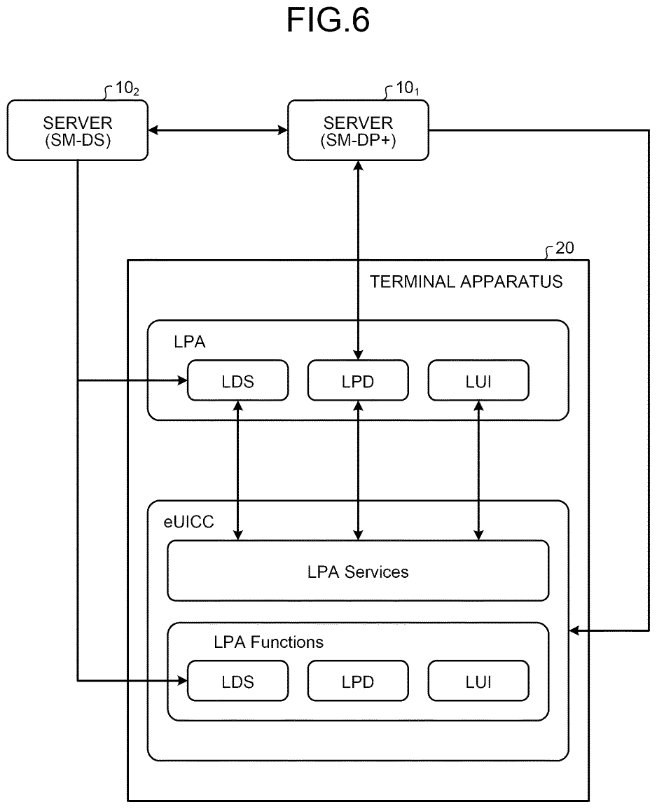

FIG. 6 is a diagram illustrating an example of an RSP architecture configuration applied to a communication system 1 according to the present embodiment. The RSP architecture illustrated in FIG. 6 includes a server 10₁ (SM-DP+), a server 10₂ (SM-SM), and a terminal apparatus 20.

The server 101 is a server called Subscription Manager-Data Preparation+ (SM-DP +). The SM-DP+ sends a profile to the LPA of the eUICC of the terminal apparatus 20.

The server 102 is a server called Subscription Manager-Discovery Server (SM-DS). The SM-DS provides one or a plurality of addresses of SM-DP+ to a local discovery service (LDS) of the terminal apparatus 20.

The terminal apparatus 20 is user equipment used in combination with the eUICC. The terminal apparatus 20 has a function related to storage and deletion of a profile related to wireless communications. As illustrated in FIG. 6, the terminal apparatus 20 includes a local profile assistant (LPA) for managing an eSIM profile, and an embedded UICC (eUICC) for storing the eSIM profile.

The LPA is a functional element (software) having a function of recording a plurality of profiles in a terminal apparatus (for example, the memory of the eUICC). The LPA has a local profile download (LPD) function, a local discovery service (LDS) function, and a local user interface (LUI) function. The LPA may be a functional element in the terminal apparatus 20, or may be a functional element in the eUICC.

The eUICC is a universal integrated circuit card (UICC) that enables local management of profiles in a secure manner. The eUICC may be mounted on a substrate in the terminal apparatus 20, or may be mounted on a card to be inserted into the terminal apparatus 20. The eUICC includes an LPA service and an LPA.

The LPA service is a functional element (software) that provides necessary access to services and data which are necessary for the LPA function. For example, a local profile assistant (LPA) is a functional element (software) that provides an LPD function, an LDS function, and a LUI function. The LPA has a function of recording a plurality of profiles in a memory of the eUICC.

### <<3. Operation of Terminal Apparatus>>

The configuration of the communication system 1 (server 10, terminal apparatus 20) has been described above. Next, the operation of the terminal apparatus 20 of the present embodiment will be described.

As described above, the current DSDA-compatible terminal apparatus is designed on the assumption that a user performs call and data communications at the same time, and it is not assumed that the terminal apparatus performs data communications by using a plurality of SIMs at the same time. In the future, it is assumed that the DSDA-compatible terminal apparatus can perform data communications using a plurality of SIMs simultaneously.

Therefore, in the present embodiment, a terminal apparatus 20 capable of simultaneous communications that simultaneously uses a plurality of data communications (hereinafter, referred to as simultaneous data communications) will be described.

Note that, in the following description, it is assumed that the terminal apparatus 20 (for example, the communication control unit 231) can simultaneously execute a plurality of data communications including the first data communication using the first profile associated with the first SIM (also referred to as SIM 1) and the second data communication using the second profile associated with the second SIM (also referred to as SIM 2). Needless to say, the terminal apparatus 20 may be configured to be able to execute the third data communication using the third profile associated with a third SIM (also referred to as SIM 3) simultaneously with the first data communication and/or the second data communication. In the following description, the profile associated with the SIM may be simply referred to as the SIM. In addition, at least some or all of the following Examples 1, 2, and 3 may be implemented in combination with at least some or all of other Examples.

### <3-1. Example 1>

First, the operation of the terminal apparatus 20 according to Example 1 will be described.

As described above, the current DSDA-compatible terminal apparatus is not assumed for data communications using two SIMs at the same time, and even if the terminal apparatus performs data communications using two SIMs at the same time, the user cannot know that. Therefore, in Example 1, a terminal apparatus 20 in which a user can easily recognize that communications are performed using a plurality of SIMs will be described. Specifically, in Example 1, a terminal apparatus 20 including a user interface (UI) that allows a user to easily recognize that data communications are performed using a plurality of SIMs will be described.

Hereinafter, the operation of the terminal apparatus 20 according to Example 1 will be described in detail.

As described above, the terminal apparatus 20 includes a display unit 251 (FIG. 4).

For example, the terminal apparatus 20 includes a display having a display area V1 on a status bar as illustrated in FIG. 5 as the display unit 251. The status bar is an area for displaying general information regarding the terminal apparatus 20 (for example, time, radio field intensity, battery state, and the like). As illustrated in FIG. 1, for example, the radio field intensity indication A1 and the radio field intensity indication A2 are displayed on the status bar. The radio field intensity indication A1 is a first radio field intensity indication related to the first data communication (radio field intensity indication of SIM 1), and the radio field intensity indication A2 is a second radio field intensity indication related to the second data communication (radio field intensity indication of SIM 2).

In Example 1, the terminal apparatus 20 (for example, the display control unit 232) displays the simultaneous data communications on the status bar. For example, the terminal apparatus 20 displays, on the status bar, an indication that makes it possible to distinguish whether simultaneous data communications are being executed or communications using any of a plurality of data communications (hereinafter, also referred to as non-simultaneous data communications or individual data communications) are being executed as the indication related to the simultaneous data communications. For example, the terminal apparatus 20 displays the indication related to the simultaneous communications in association with the indication related to the first data communication (for example, radio field intensity indication A1) and the indication related to the second data communication (for example, radio field intensity indication A2).

Hereinafter, a display example regarding simultaneous data communications according to Example 1 will be described.

### (1) First Display Example

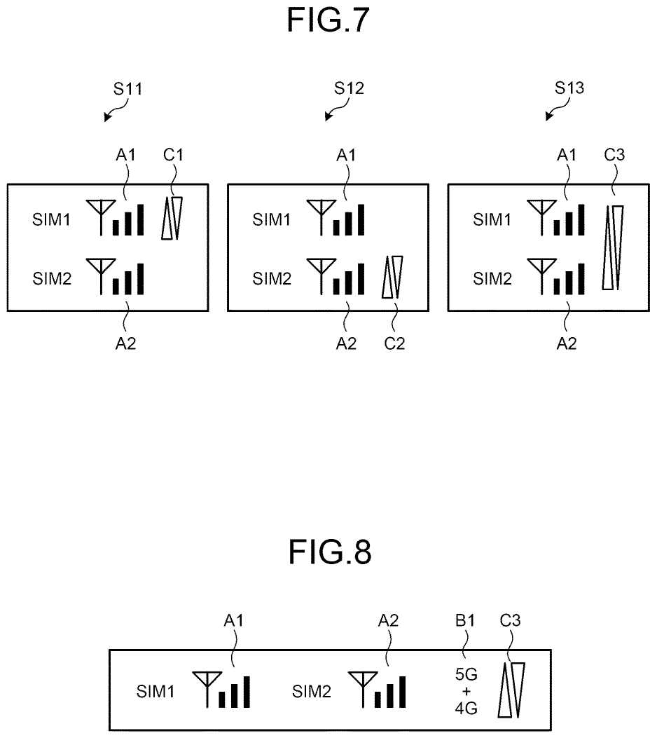

FIG. 7 is a diagram illustrating the first display example according to Example 1. When performing data communications (non-simultaneous data communications) using the profile of the SIM 1 or the SIM 2, the terminal apparatus 20 displays a communication icon at locations corresponding to each SIM indicator. For example, when performing data communications using the profile of the SIM 1 (S11), the terminal apparatus 20 displays a communication icon C1 next to the radio field intensity indication A1 (right adjacent or left adjacent) as illustrated in state S11 of FIG. 7. In addition, when performing data communications using the profile of the SIM 2 (S12), the terminal apparatus 20 displays a communication icon C2 next to the radio field intensity indication A2 (right adjacent or left adjacent) as illustrated in state S12 of FIG. 7.

On the other hand, when performing data communications (simultaneous data communications) using both profiles of the SIM 1 and the SIM 2 (S13), the terminal apparatus 20 displays a communication icon so as to cover both SIM indicators of the SIM 1 and the SIM 2. For example, when performing data communications using both profiles of the SIM 1 and the SIM 2, the terminal apparatus 20 displays a communication icon C3 so as to cover both of the radio field intensity indication A1 and the radio field intensity indication A2 as illustrated in state S13 of FIG. 7. In this case, the communication icon C3 is displayed on the right or left of both of the radio field intensity indication A1 and the radio field intensity indication A2.

Note that the communication icons C1 to C3 may be indications that make it possible to distinguish the communication type of data communications. For example, the communication icons C1 to C3 may be icons indicating a communication direction (for example, uploading, downloading, or both uploading and downloading). In the example of FIG. 7, an upward triangle is indicated (highlighted) when the communication direction is uploading, a downward triangle is indicated (highlighted) when the communication direction is downloading, and both the upward triangle and the downward triangle are indicated (highlighted) when the communication direction has both directions. Further or alternatively, the communication icons C1 to C3 may be icons indicating uplink or downlink as a communication direction. In the example of FIG. 7, an upward triangle is indicated (highlighted) when the communication direction is uplink, a downward triangle is indicated (highlighted) when the communication direction is downlink, and both the upward triangle and the downward triangle are indicated (highlighted) when the communication direction has both directions. That is, the communication icon (C1, C2, or C3) of data communications is changed depending on which one of the SIM 1 and the SIM 2 or the combination of both profiles is used for data communications (S11, S12, or S13).

### (2) Second Display Example

FIG. 8 is a diagram illustrating a second display example according to Example 1. When performing data communications (simultaneous data communications) using both profiles of the SIM 1 and the SIM 2, the terminal apparatus 20 displays a communication icon indicating that the simultaneous communications are being executed. For example, when performing data communications using both profiles of the SIM 1 and the SIM 2, the terminal apparatus 20 displays a communication icon B1 on the status bar as illustrated in FIG. 8. In the example of FIG. 8, the communication icon B1 is an indication for the type of radio access technology (RAT) of the first data communication and the second data communication. In the example of FIG. 8, the communication icon B1 is “5G+4G”, but is not limited to this example, and may be, for example, “5G+5G”, “4G+4G”, “4G+5G”, or the like. In the example of FIG. 8, the indication for the type of RAT of the first data communication and the second data communication is displayed on the right of the radio field intensity indication A2, but the present invention is not limited to this example. For example, the indication for the type of RAT of the first data communication and the second data communication may be displayed on the left of the radio field intensity indication A1, or may be displayed on the right of the radio field intensity indication A1 and on the left of the radio field intensity indication A2.

Furthermore, when performing data communications using both profiles of the SIM 1 and the SIM 2, the terminal apparatus 20 may display the communication icon C3 next to (on the right or left of) the communication icon B1, as illustrated in FIG. 8. The communication icon C3 is an indication that makes it possible to distinguish the communication type of data communications. For example, the communication icon C3 is an icon indicating a communication direction (for example, uploading, downloading, or both directions of uploading and downloading). In addition, the communication direction indicated by the communication icon C3 may be associated with the type of RAT indicated by the communication icon B1. For example, it is assumed that download communication is performed in 5G using the profile of the SIM 1 and upload communication is performed in 4G using the profile of the SIM 2. In this case, when download communication is being performed, the communication icon B1 indicating 5G and the communication icon C3 indicating download communication may be simultaneously displayed. Further or alternatively, when upload communication is being performed, the communication icon B1 indicating 4G and the communication icon C3 indicating upload communication may be simultaneously displayed.

### (3) Third Display Example

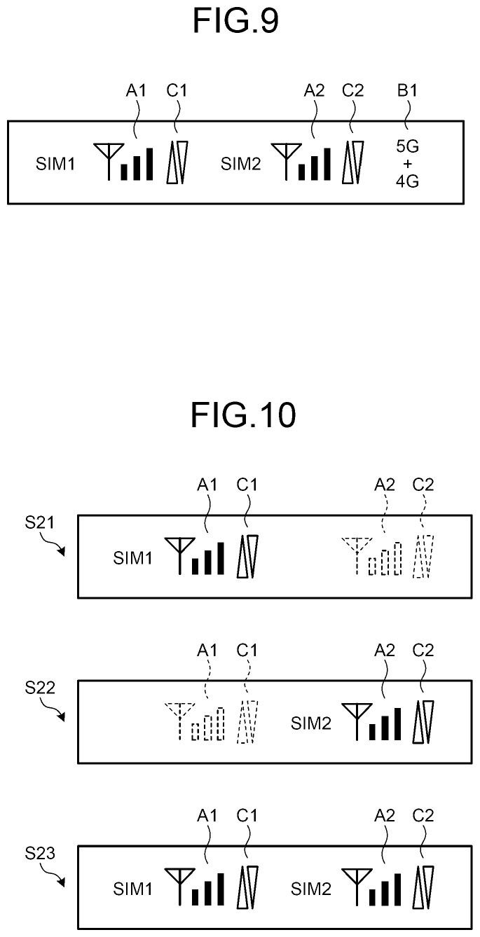

FIG. 9 is a diagram illustrating the third display example according to Example 1. When performing data communications (simultaneous data communications) using both profiles of the SIM 1 and the SIM 2, the terminal apparatus 20 displays a communication icon indicating that the simultaneous communications are being executed. For example, when performing data communications using both profiles of the SIM 1 and the SIM 2, the terminal apparatus 20 displays a communication icon B1 on the status bar as illustrated in FIG. 9. In the example of FIG. 9, the communication icon B1 is an indication for the type of radio access technology (RAT) of the first data communication and the second data communication. In the example of FIG. 9, the communication icon B1 is “5G+4G”, but is not limited to this example, and may be, for example, “5G+5G”, “4G+4G”, “4G+5G”, or the like.

In addition, when performing data communications (simultaneous data communications and/or non-simultaneous data communications) using the profile of the SIM 1 and/or the SIM 2, the terminal apparatus 20 displays a communication icon at a location corresponding to each SIM indicator. For example, when performing non-simultaneous data communications using the profile of the SIM 1, the terminal apparatus 20 displays the communication icon C1 next to the radio field intensity indication A1, and does not display the communication icon C2 next to the radio field intensity indication A2. Further, when performing non-simultaneous data communications using the profile of the SIM 2, the terminal apparatus 20 displays the communication icon C2 next to the radio field intensity indication A2, and does not display the communication icon C1 next to the radio field intensity indication A1. Furthermore, when performing simultaneous data communications using the both profiles of the SIM 1 and the SIM 2, the terminal apparatus 20 displays the communication icon C1 next to the radio field intensity indication A1, and display the communication icon C2 next to the radio field intensity indication A2. Note that the meaning of “does not display” here may be grayed out.

Here, the communication icon C1 and the communication icon C2 are indications that make it possible to distinguish the communication type of data communications. For example, the communication icon C1 and the communication icon C2 are icons indicating a communication direction (for example, uploading, downloading, or both uploading and downloading). The communication type is not limited to the communication direction. For example, the communication type may be a type of RAT (for example, wireless LAN, 4G, 5G, or 6G), a link type (for example, sidelink, uplink, or downlink), or a communication form with a base station (for example, whether communication is performed by using a plurality of component carriers such as carrier aggregation/dual connectivity).

### (4) Fourth Display Example

FIG. 10 is a diagram illustrating the fourth display example according to Example 1. When performing data communications (non-simultaneous data communications) using the profile of the SIM 1 or the SIM 2, the terminal apparatus 20 highlights the indication of SIM being used for the communications, and displays a communication icon at a location corresponding to the indicator. At this time, the terminal apparatus 20 deletes (grays out) an indication of a SIM unused and the communication icon corresponding to the indication.

For example, when performing non-simultaneous data communications using the profile of the SIM 1, the terminal apparatus 20 displays (highlights) the radio field intensity indication A1 on the status bar and displays the communication icon C1 next to the radio field intensity indication A1 as illustrated in state S21 of FIG. 10. Then, the terminal apparatus 20 deletes (grays out) the radio field intensity indication A2 and the communication icon C2. On the other hand, when performing non-simultaneous data communications using the profile of the SIM 2, the terminal apparatus 20 displays (highlights) the radio field intensity indication A2 on the status bar and displays the communication icon C2 next to the radio field intensity indication A2 as illustrated in state S22 of FIG. 10. Then, the terminal apparatus 20 deletes (grays out) the radio field intensity indication A1 and the communication icon C1.

In addition, when performing simultaneous data communications using both profiles of the SIM 1 and the SIM 2, the terminal apparatus 20 displays (highlights) SIM indicators of both the SIM 1 and the SIM 2, and displays a communication icon on each of the SIM indicators. For example, when performing simultaneous data communications using both profiles of the SIM 1 and the SIM 2, the terminal apparatus 20 displays (highlights) both the radio field intensity indication A1 and the radio field intensity indication A2 as illustrated in state S23 of FIG. 10. Then the terminal apparatus 20 displays the communication icon C1 next to the radio field intensity indication A1, and displays the communication icon C2 next to the radio field intensity indication A2.

Here, the communication icon C1 and the communication icon C2 are indications that make it possible to distinguish the communication type of data communications. For example, the communication icon C1 and the communication icon C2 are icons indicating a communication direction (for example, uploading, downloading, or both uploading and downloading). The communication type is not limited to the communication direction, and may be, for example, a type of RAT, a link type, or a communication form with a base station.

According to Example 1, the user can easily recognize that the terminal apparatus 20 is performing data communications using a plurality of SIMs.

### <3-2. Example 2>

Next, the operation of the terminal apparatus 20 according to Example 2 will be described.

In Example 2, the terminal apparatus 20 displays an indication for associating the SIM with the application on the display unit 251. For example, the terminal apparatus 20 displays an icon indicating an application and the SIM used by the application for data communications on the status bar. Note that the terminal apparatus 20 may cause a specific application to use a specific SIM in preference to other applications. At this time, the terminal apparatus 20 may display, on a user interface (UI), that the specific application occupies the specific SIM and communicates.

Hereinafter, a display example regarding simultaneous data communications according to Example 2 will be described.

### (1) First Display Example

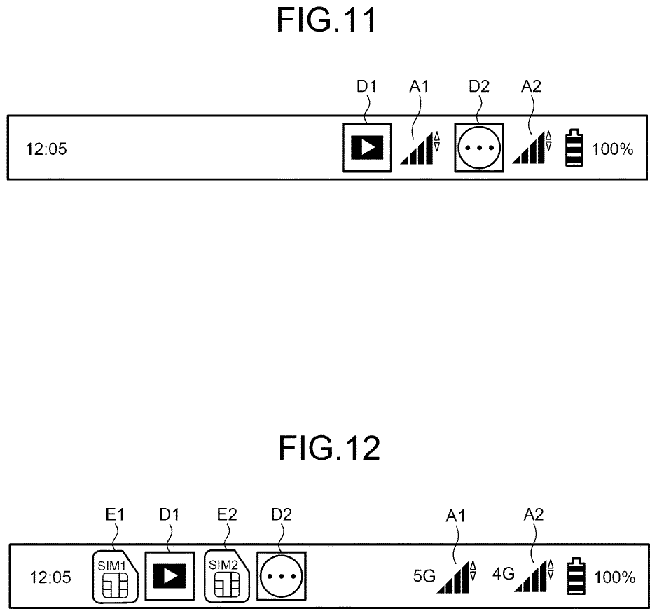

FIG. 11 is a diagram illustrating the first display example according to Example 2. As described above, the terminal apparatus 20 includes the display unit 251 having the display area of the status bar. The radio field intensity indication A1 and the radio field intensity indication A2 are displayed on the status bar, for example. The radio field intensity indication A1 is a first radio field intensity indication related to the first data communication (radio field intensity indication of SIM 1), and the radio field intensity indication A2 is a second radio field intensity indication related to the second data communication (radio field intensity indication of SIM 2).

In the first display example, the terminal apparatus 20 displays the radio field intensity indications in association with indications related to simultaneous data communications. For example, the terminal apparatus 20 displays a first indication indicating use of the first data communication by the first application and a second indication indicating use of the second data communication by one or a plurality of other applications in association with the radio field intensity indication as indications related to the simultaneous data communications. In the example of FIG. 11, the terminal apparatus 20 displays an icon D1 (first indication) indicating the first application in association with the radio field intensity indication A1, and displays an icon D2 (second indication) indicating one or a plurality of other applications in association with the radio field intensity indication A2.

### (2) Second Display Example

FIG. 12 is a diagram illustrating the second display example according to Example 2. In the second display example, the terminal apparatus 20 displays a dedicated icon in association with an indication related to simultaneous data communications. For example, the terminal apparatus 20 displays the first indication indicating use of the first data communication by the first application and the second indication indicating use of the second data communication by one or a plurality of other applications in association with the dedicated icon as indications related to the simultaneous data communications. In the example of FIG. 12, the terminal apparatus 20 displays the icon D1 (first indication) indicating the first application in association with a SIM indicator E1, and displays the icon D2 (second indication) indicating one or a plurality of other applications in association with a SIM indicator E2. The SIM indicator E1 is a dedicated icon (indication for SIM 1) related to the first data communication, and the SIM indicator E2 is a dedicated icon (indication for SIM 2) related to the second data communication.

According to Example 2, the user can easily recognize which application is using the SIM. For example, the user can easily recognize an application that preferentially uses a specific SIM.

### <3-3. Example 3>

Next, the operation of the terminal apparatus 20 according to Example 3 will be described.

A conventional DSDS-compatible terminal apparatus is configured such that a user selects a SIM (data communication priority SIM) to be used for data communications from a plurality of SIMs in a user setting. As described above, in the future, it is assumed that the DSDA-compatible terminal apparatus can perform data communications using a plurality of SIMs simultaneously. However, currently, there is no user interface (for example, a UI that enables adding a plurality of SIMs as SIMs to be used for data communications) for simultaneously using a plurality of SIMs for data communications. Therefore, it is necessary to provide a means (UI) capable of appropriately adding a SIM to be used for data communications at a timing intended by the user.

In Example 3, the terminal apparatus 20 displays, on the display unit 251, a user interface (first user interface, sometimes referred to as user-selectable interface or icon) capable of associating an application with two or more data communications among a plurality of data communications as an indication related to simultaneous data communications.

Hereinafter, a display example regarding simultaneous data communications according to Example 3 will be described.

### (1) First Display Example

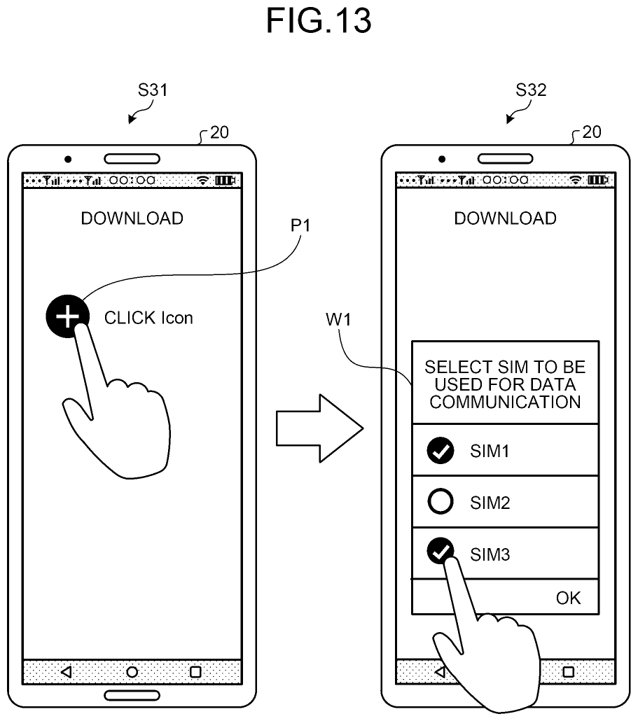

FIG. 13 is a diagram illustrating the first display example according to Example 3. In the first display example, when data communication (downloading or uploading) related to an application is executed, the terminal apparatus 20 displays a user-selectable interface for selecting one or a plurality of SIMs to be used for the data communication.

For example, the terminal apparatus 20 displays an icon P1 on the display unit 251 when data communication (in the example of FIG. 13, downloading) is executed as illustrated in state S31. The icon P1 is a user-selectable interface for displaying a SIM list (for example, a window W1 to be described later) available for the data communication. Note that the terminal apparatus 20 may display the user interface (the icon P1 and/or the window W1) in a case where the data size of downloading or uploading is larger than a predetermined threshold.

Then, in response to the icon P1 being selected (e.g., clicked or tapped), for example, as illustrated in state S32, the terminal apparatus 20 displays the window W1 for selecting one or a plurality of SIMs to be used for the data communication as a user interface. In the example of FIG. 13, indications of the SIM 1, the SIM 2, and the SIM 3 are listed as the SIMS selectable by the user in the window W1. Note that, if there is another available RAT (for example, a wireless LAN such as Wi-Fi), the terminal apparatus 20 may also include the RAT in the list. In addition, the information of the MNO operator corresponding to each SIM (MNO name or service name, carrier name) may be displayed next to or around the indication of the SIM in association with each SIM.

Note that when data communication is performed, the terminal apparatus 20 may directly display the window W1 on the display unit 251 without using the icon P1. For example, when the data size of the data communication is larger than a predetermined threshold, the terminal apparatus 20 may directly display the window W1 on the display unit 251 without using the icon P1.

When one or a plurality of SIMs are selected from the options, the terminal apparatus 20 performs data communication (in the example of FIG. 13, downloading) by using the selected one or plurality of SIMs. Note that the terminal apparatus 20 may store the information of the selected one or plurality of SIMs in the storage unit 22 in association with the application. Then, the terminal apparatus 20 (for example, the setting unit 233) may determine the selected one or plurality of SIMs (the selected one or plurality of data communications) as a default setting when the application performs data communications in the next and subsequent times.

### (2) Second Display Example

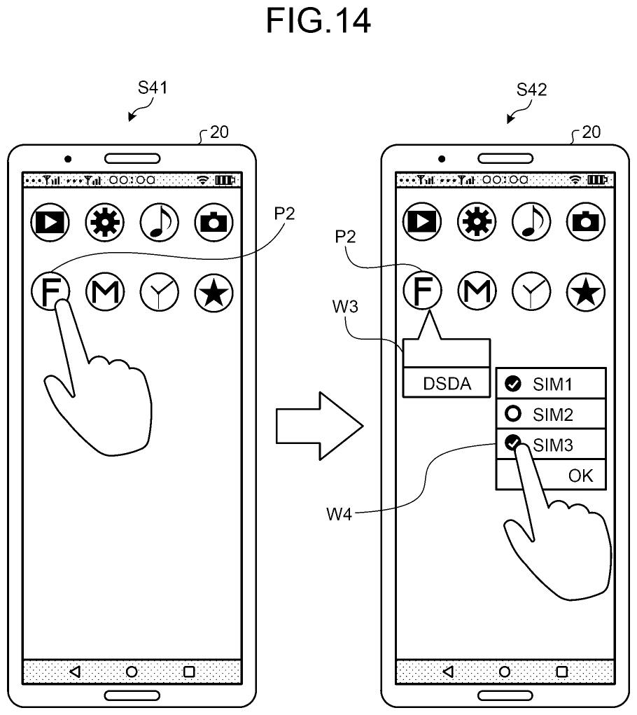

FIG. 14 is a diagram illustrating the second display example according to Example 3. In the second display example, in response to a predetermined operation performed on the icon of the application displayed on the display unit 251, the terminal apparatus 20 displays a user selectable indication for selecting one or a plurality of SIMs to be used for data communications of the application.

For example, when the icon P2 of the application is held down at the time of activation of the application as illustrated in state S41, the terminal apparatus 20 displays a window for selecting one or a plurality of SIMs to be used for data communications of the application as illustrated in state S42, for example. In the example of FIG. 14, the terminal apparatus 20 displays a window W3 for allowing the user to select an activation option. The window W3 is a window for asking the user whether or not to use the function of the DSDA. Further or alternatively, if the icon P2 of the application is tapped when the activation of the application illustrated in state S41 is an initial activation (first activation after installation of the application, or first activation after power on or restart of the terminal apparatus 20), a window for selecting one or a plurality of SIMs to be used for data communications of the application may be displayed as illustrated in state S42. In this case, the tap of the icon P2 is not necessarily held down.

If the user selects to use the function of the DSDA, the terminal apparatus 20 displays a window W4 for selecting one or a plurality of SIMs to be used for the data communication of the application as a user interface. In the example of FIG. 14, the SIM 1, the SIM 2, and the SIM 3 are listed as the SIMS selectable by the user in the window W4. Note that, if there is another available RAT (for example, a wireless LAN such as Wi-Fi), the terminal apparatus 20 may also include the RAT in the list. In addition, the information of the MNO operator corresponding to each SIM (MNO name or service name, carrier name) may be displayed next to or around the indication of the SIM in association with each SIM.

Note that when data communication is performed, the terminal apparatus 20 may directly display the window W4 on the display unit 251 without using the icon P2. For example, when the data size of the data communication is larger than a predetermined threshold, the terminal apparatus 20 may directly display the window W4 on the display unit 251 without using the icon P2.

When one or a plurality of SIMs are selected from the options, the terminal apparatus 20 performs data communication by using the selected one or plurality of SIMs. Note that the terminal apparatus 20 may store the information of the selected one or plurality of SIMs in the storage unit 22 in association with the application. Then, the terminal apparatus 20 (for example, the setting unit 233) may set the selected one or plurality of SIMs (the selected one or plurality of data communications) as a default setting when the application performs data communications in the next and subsequent times.

### (3) Third Display Example

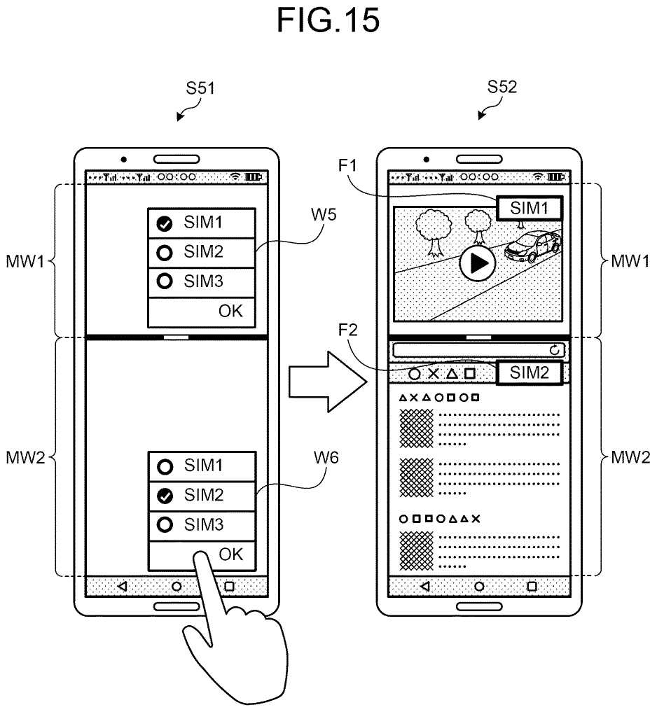

FIG. 15 is a diagram illustrating the third display example according to Example 3. In the third display example, under a condition a multi-window is displayed on the display unit 251, the terminal apparatus 20 displays a user-selectable indication for selecting one or a plurality of SIMs to be used for data communications of the application displayed on the multi-window. The multi-window is a window including a plurality of windows for displaying applications. In the example of FIG. 15, two windows, a window MW1 and a window MW2, are displayed as windows constituting the multi-window.

In the third display example, the terminal apparatus 20 displays a user interface for associating the SIM used for data communication with each of the plurality of windows constituting the multi-window (the window MW1 and the window MW2 in the example of FIG. 15), for example, as illustrated in state S51. In the example of FIG. 15, the terminal apparatus 20 displays a window W5 as a user interface in the window MW1, and displays a window W6 as a user interface in the window MW2. In the example of FIG. 15, the SIM 1, the SIM 2, and the SIM 3 are listed as the SIMS selectable by the user in the window W5 and the window W6. Note that, if there is another available RAT (for example, a wireless LAN such as Wi-Fi), the terminal apparatus 20 may also include the RAT in the list. In addition, the information of the MNO operator corresponding to each SIM (MNO name or service name, carrier name) may be displayed next to or around the indication of the SIM in association with each SIM. In the example of FIG. 15, only one SIM is selected per window, but the terminal apparatus 20 may be configured such that a plurality of SIMs can be selected per window. In addition, one or a plurality of SIMs associated with the window may be the same as one or a plurality of SIMs associated with other windows constituting the multi-window.

Note that the terminal apparatus 20 may be configured to be able to execute association of the SIM with the window when the multi-window screen is started. For example, the terminal apparatus 20 may display a user interface (the window W5 and/or the window W6 in the example of FIG. 15) for associating the SIM with the window when starting the multi-window screen. Generally, the terminal apparatus 20 may be configured to be able to execute association of the SIM with the window in advance (before the multi-window screen is started). For example, the terminal apparatus 20 may be configured to be able to display a setting screen for associating the SIM with the window. In addition, the terminal apparatus 20 may be configured to be able to execute association of the SIM with the window after the multi-window screen is started. For example, the terminal apparatus 20 may display a window for changing the SIM used for data communication when a predetermined operation is performed on the window constituting the multi-window.

When the multi-window screen is started, the terminal apparatus 20 performs data communication by using the selected one or plurality of SIMs. Note that the terminal apparatus 20 may display an indication indicating the SIM used for performing data communications in each of a plurality of windows constituting the multi-window, for example, as illustrated in state S52. That is, the terminal apparatus 20 may display an indication indicating data communications used by the application displayed in each of the plurality of windows constituting the multi-window. For example, as illustrated in state S52, the terminal apparatus 20 may display an indication F1 indicating that the SIM 1 is used in the window MW1 and display an indication F2 indicating that the SIM 2 is used in the window MW2.

According to Example 3, the user can appropriately add a SIM to be used for data communications at an timing intended.

### <3-4. Example 4>

Next, the operation of the terminal apparatus 20 according to Example 4 will be described.

In Example 4, a user interface (second user interface) capable of associating time with two or more data communications among a plurality of data communications as an indication related to simultaneous data communications. The user presets, by using this user interface, a SIM that performs data communication at a specific time. For example, in a time zone in which communication is congested, the user sets a SIM advantageous for the time zone. Alternatively, the user performs setting to simultaneously use a plurality of SIMs in the time zone in which communication is congested. The terminal apparatus 20 changes the SIM used for data communication at the timing when the time set on the user interface has come.

Hereinafter, a display example regarding simultaneous data communications according to Example 4 will be described.

### (1) First Display Example

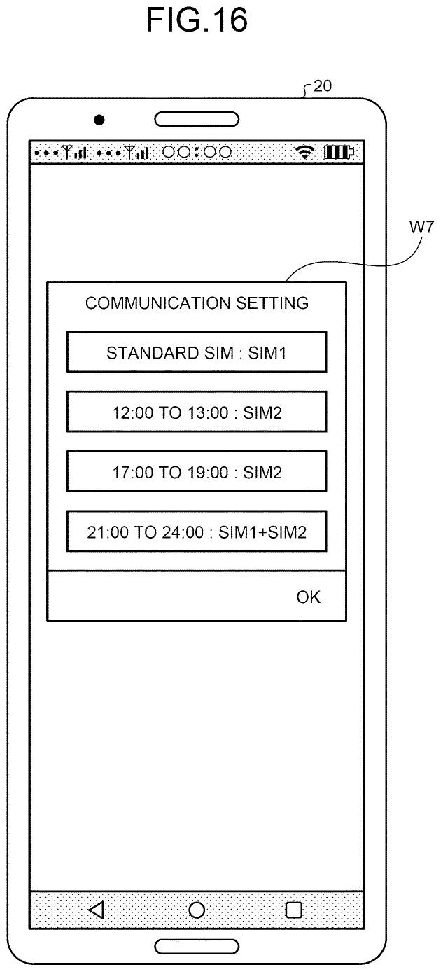

FIG. 16 is a diagram illustrating the first display example according to Example 4. The terminal apparatus 20 displays, on the display unit 251, a window W7 that enables pre-setting by the user as a user interface. The user uses the window W7 to set the time zone and the SIM to be used in the time zone. In the example of FIG. 16, in the terminal apparatus 20, the SIM 2 is set as the SIM to be used at 12:00 to 13:00, the SIM 2 is set as the SIM to be used at 17:00 to 19:00, and two SIMs, SIM 1 and SIM 2, are set as the SIMS to be used at 21:00 to 24:00. In addition, in the example of FIG. 16, the SIM 1 is set as the standard SIM (for example, Default Data SIM). The standard SIM is, for example, a SIM used in other than the above time zones. The terminal apparatus 20 changes the SIM used for data communication at the timing when the time set on the window W7 has come.

### (2) Second Display Example

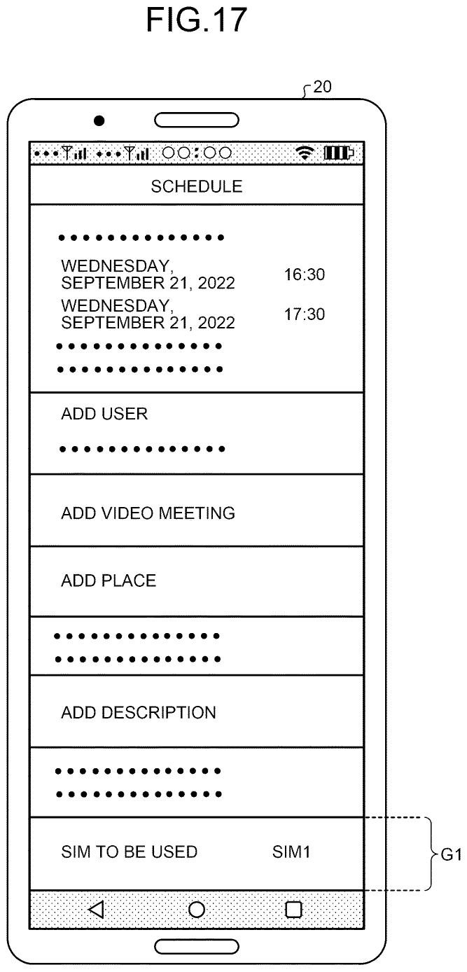

FIG. 17 is a diagram illustrating the second display example according to Example 4. The terminal apparatus 20 displays, as a user interface, a schedule input interface (schedule input screen) to which a SIM to be used for data communications can be input. In the example of FIG. 17, an area G1 for setting a SIM to be used for data communications is provided in the schedule input interface (schedule input screen).

The user configures, by using the schedule input interface, the SIM to be used for data communications. In the example of FIG. 17, the SIM 1 is set as the SIM to be used at 16:30 to 17:30 on Sep. 21, 2022. Although only one SIM is set in one time zone (one event) in the example of FIG. 17, the terminal apparatus 20 may be configured to be able to set a plurality of SIMs in one time zone (one event).

### (3) Application Example

Note that the terminal apparatus 20 may automatically switch the SIM to be used in the time zone of an event from its event content input to the schedule input interface. For example, the user associates the event content with the SIM to be used in the event content by using a predetermined user interface. For example, the user sets, by using the predetermined user interface, that a SIM for business is used at work, and a private SIM is used at other times. At this time, the user may set a plurality of SIMs in one event content. Then, the terminal apparatus 20 presumes which one of the user's settings (for example, at work or other times) the user's event corresponds to, from the content input to the schedule input interface. Then, the terminal apparatus 20 switches the SIM according to the presumed result.

In addition, the terminal apparatus 20 may acquire failure information from a server on the network (for example, a web server that monitors and transmits failure information), and if a failure occurs, may avoid using the SIM for the communication service in which the failure occurs.

According to Example 3, the user can appropriately switch a SIM to be used for data communications at a timing intended.

### <<4. Modifications>>

The above-described embodiments are examples, and various modifications and applications are possible.

For example, in Example 1 and Example 2, indications related to the simultaneous data communications are displayed on the status bar, but the display portion is not limited to the status bar. The terminal apparatus 20 may display the indications related to the simultaneous data communications in a place other than the status bar.

In addition, in Example 2, the application using the second data communication is an application different from the first application (one or a plurality of other applications). At this time, the application using the second data communication may be all applications other than the first application, or may be one or a plurality of applications selected from one or a plurality of applications other than the first application. Also, the application using the second data communication may be the same application as the application using the first data communication. In addition, there may be a plurality of applications that use the first data communication.

Furthermore, in the above-described embodiment, simultaneous communications are specified as simultaneous data communications that simultaneously use a plurality of data communications including the first data communication using the first profile associated with the first SIM and the second data communication using the second profile associated with the second SIM. However, the simultaneous communications of the present embodiment are not limited thereto, and may be, for example, communications that simultaneously use a plurality of data communications including data communications using a wireless LAN and data communications using a mobile network. In addition, the simultaneous communications may be communications that simultaneously use data communications and communications other than data communications. The simultaneous data communications described above can be replaced with simultaneous communications as appropriate.

In addition, the terminal apparatus 20 may include only one function selected from among the plurality of functions described in Examples 1 to 4, or may include two or more functions selected from among the plurality of functions. Needless to say, the terminal apparatus 20 may have all the functions described in Examples 1 to 4.

The control apparatus that controls the server 10 or the terminal apparatus 20 of the present embodiment may be realized by a dedicated computer system or a general-purpose computer system.

For example, a communication program for executing the above-described operations is stored and distributed in a computer-readable recording medium such as an optical disk, a semiconductor memory, a magnetic tape, or a flexible disk. Then, for example, the program is installed in a computer, and the above-described processing is executed to configure the control apparatus. At this time, the control apparatus may be an external apparatus of the server 10 or the terminal apparatus 20 (for example, a personal computer). Furthermore, the control apparatus may be an internal apparatus of the server 10 or the terminal apparatus 20 (for example, the control unit 13 or the control unit 23).

In addition, the communication program may be stored in a disk drive included in a server device on a network such as the Internet so that the communication program can be downloaded to a computer. In addition, the above-described functions may be realized by cooperation of an operating system (OS) and application software. In this case, a portion other than the OS may be stored in a medium and distributed, or a portion other than the OS may be stored in the server device and downloaded to a computer.

Among the processes described in the above embodiments, all or a part of the processes described as being performed automatically can be performed manually, or all or a part of the processes described as being performed manually can be performed automatically by a known method. In addition, the processing procedure, specific name, and information including various data and parameters illustrated in the above-described specification and the drawings can be arbitrarily changed unless otherwise specified. For example, the various types of information illustrated in the drawings are not limited to the illustrated information.

In addition, each elements of the illustrated apparatuses is functionally conceptual, and does not necessarily have to be physically configured as illustrated. That is, the specific form of distribution and integration of the apparatuses is not limited to the illustrated form, and all or a part thereof can be functionally or physically distributed and integrated in an arbitrary unit according to various loads, usage conditions, and the like. Note that this distributed or integrated configuration may be performed dynamically.

In addition, the above-described embodiments can be appropriately combined in a region in which the processing contents do not contradict each other. In addition, the order of each processing of the above-described embodiments can be appropriately changed.

Furthermore, for example, the present embodiment can be implemented as any configuration constituting an apparatus or a system, for example, a processor as a system large scale integration (LSI) or the like, a module using a plurality of processors or the like, a unit using a plurality of modules or the like, a set obtained by further adding other functions to the unit, or the like (that is, a configuration of a part of the apparatus).

Note that, in the present embodiment, the system means a set of a plurality of components (apparatuses, modules (parts), etc.), and it does not matter whether or not all the elements are in the same housing. Therefore, a plurality of apparatuses housed in separate housings and connected via a network and one apparatus in which a plurality of modules is housed in one housing are both systems.

Furthermore, for example, the present embodiment can adopt a configuration of cloud computing in which one function is shared and processed by a plurality of apparatuses in cooperation via a network.

### <<5. Conclusion>>

As described above, according to an embodiment of the present disclosure, the terminal apparatus 20 can execute simultaneous communications that simultaneously use a plurality of data communications including the first data communication using the first profile associated with the first SIM and the second data communication using the second profile associated with the second SIM. Then, the terminal apparatus 20 displays an indication related to the simultaneous communications on the display unit 251. As a result, even in a case where a plurality of wireless communications of the same type are simultaneously used, the user can know in detail how the wireless communications are used. As a result, the convenience of the terminal apparatus 20 is improved.

Although the embodiments of the present disclosure have been described above, the technical scope of the present disclosure is not limited to the above-described embodiments as it is, and various modifications can be made without departing from the gist of the present disclosure. In addition, elements of different embodiments and modifications may be appropriately combined.

Furthermore, the effects of each embodiment described in the present specification are merely examples and are not limited, and other effects may be provided.

Note that the present technology can also have the following configurations.

(1)

A communication apparatus comprising:
circuitry configured to
perform first radio communication using first profile data of a first Subscriber Identify Module (SIM), and perform second radio communication using second profile data of a second SIM,
cause a screen of the communication apparatus to display a first indicator of a communication state of the first radio communication under an operational condition in which the first radio communication is active, and
cause the screen to display a second indicator of a communication state of the second radio communication under another condition that the second radio communication is active.
   (2)

The communication apparatus of (1), further comprising:
the screen, wherein the circuitry is configured to cause the first indicator and the second indicator to be displayed on a portion of the screen that is different than a window in which an application is displayed.
   (3)

The communication apparatus of any one of (1)-(2), wherein the first indicator includes a field intensity indicator of the first radio communication, and the second indicator includes a field intensity indicator of the second radio communication.

(4)

The communication apparatus of (3), wherein the circuitry is also configured to display a communication icon on the screen in association with at least one of the first indicator and the second indicator, the communication icon includes displayed information regarding an activation status of at least one of the first radio communication and the second radio communication.

(5)

The apparatus of any one of (1)-(4), wherein the circuitry is configured to support remote SIM provisioning of the first SIM and the second SIM that rewrites profile information for at least one of the first SIM and the second SIM without physical replacement of either the first SIM or the second SIM.

(6)

The apparatus of (5), further comprising:
an embedded universal integrated circuit card (eUICC), wherein the profile information is an eSIM profile and includes a combination of data and an application provisioned on a memory of the eUICC.
   (7)

The apparatus of (6), wherein the circuitry is further configured to implement a local profile assistant that records a plurality of profiles in the memory of the eUICC.

(8)

The communication apparatus of any one of (1)-(7), wherein the circuitry is configured to simultaneously perform data communications according to the first profile data and also perform data communications according to the second profile data.

(9)

The communication apparatus of any one of (1)-(8), wherein the circuitry is also configured to display on the screen at least one communication icon that indicates a direction of communication in association with at least one of the first indicator and the second indicator.

(10)

The communication apparatus of any one of (1)-(9), wherein the circuitry is also configured to cause the screen to display at least one communication icon in association with at least one of the first indicator and the second indicator, the communication icon indicates a type of radio access technology used with at least one of the first radio communication and the second radio communication.

(11)

The communication apparatus of (9), wherein the at least one communication icon includes
a first communication icon that is displayed adjacent to the first indicator, and
a second communication icon that is displayed adjacent to the second indicator.
   (12)

The communication apparatus of (10), wherein the first communication icon is displayed in a highlighted state under a condition the first radio communication is active for data communication, the highlighted state being highlighted with respect to a displayed state of the second communication icon under a condition the second radio communication is active but not used for data communication.

(13)

The communication apparatus of any one of (1)-(12), wherein the circuitry is also configured to cause the screen to display a first application icon adjacent to the first indicator, and a second application icon adjacent to the second indicator, the first application icon being an indication of a first application that is being run on the communication apparatus and that uses data communications via the first radio communication according to the first profile data, and the second application icon being an indication of a second application that is being run on the communication apparatus and that uses data communications via the second radio communication according to the second profile data.

(14)

The communication apparatus of any one of (1)-(13), wherein the circuitry is also configured to display on the screen a first application icon adjacent to a first SIM indictor, and a second application icon adjacent to the second SIM indicator.

(15)

The communication apparatus of any one of (1)-(14), wherein
the circuitry is configured to cause the first radio communication to support data communications for a first application that is run on the communication apparatus, and
cause the second radio communication to support data communications for a second application that is run on the communication apparatus.
   (16)

The communication apparatus of (15), wherein the circuitry is configured to
display user-selectable icons on the screen,
in response to an actuation of a first user-selectable icon, the circuitry causes the first radio communication to support data communications for the first application, and
in response to an actuation of a second user-selectable icon, the circuitry causes the second radio communication to support data communications for the second application.
   (17)

The communication apparatus of any one of (1)-(16),
wherein the circuitry is configured to display a plurality of user-selectable SIM indicators on the screen,
a first SIM indicator of the user-selectable SIM indicators is for the first SIM and a second SIM indicator of the user-selectable SIM indicators is for the second SIM, in response to an actuation of a first user-selectable SIM indicator of the user-selectable SIM indicators, the circuitry is configured to cause the first radio communication to support data communications for at least one application, and in response to an actuation of a second user-selectable SIM indicator of the user-selectable SIM indicators, the circuitry is configured to cause the second radio communication to support data communications for the at least one application.
   (18)

The communication apparatus of (17), wherein the circuitry is configured to display on the screen the plurality of user-selectable SIM indicators in response to execution of downloading or uploading related to the at least one application.

(19)

The communication apparatus of (18), wherein the circuitry is configured to display the plurality of user-selectable SIM indicators in response to data size of the downloading or the uploading being larger than a predetermined threshold.

(20)

The communication apparatus of (17), wherein the circuitry is configured to display on the screen the plurality of user-selectable SIM indicators in response to an operation for an icon of the at least one application displayed on the screen.

(21)

The communication apparatus of any one of (1)-(20), further comprising:
the screen, the screen being a touchscreen having a first window on which the first application being run on the communication apparatus is active, and a second window on which the second application being run on the communication apparatus is active, wherein
the circuitry is configured to
display a plurality of user-selectable SIM indicators in the first window, the plurality of user-selectable SIM indicators including a first user-selectable SIM indicator for the first SIM and a second user-selectable SIM indicator for the second SIM,
in response to an actuation of the first user-selectable SIM indicator in the first window, cause the first radio communication to support data communications for the first application that is active on the first window,
display the plurality of user-selectable SIM indicators in the second window,
in response to an actuation of the first user-selectable SIM indicator in the second window, cause the first radio communication to support data communications for the second application that is active on the second window, and
in response to an actuation of the second user-selectable SIM indicator in the second window, cause the second radio communication to support data communications for the second application that is active on the second window.
   (22)

The communication apparatus of any one of (1)-(21), further comprising:
the screen, the screen being a touchscreen, wherein the circuitry is configured to
display a set of user-selectable options that include a user-selectable option for one of the first SIM or the second SIM, each of the user-selectable options being one of a time zone, or an event.
   (23)

An information processing method for a communication apparatus comprising:
performing first radio communication using first profile data of a first Subscriber Identify Module (SIM), and performing second radio communication using second profile data of a second SIM;
causing a screen of the communication apparatus to display a first indicator of a communication state of the first radio communication under an operational condition in which the first radio communication is active; and
causing the screen to display a second indicator of a communication state of the second radio communication under another condition that the second radio communication is active.
   (24)

A non-transitory computer readable memory having computer readable instructions that are stored therein that upon execution by processing circuitry configure the processing circuitry to perform a method in a communication apparatus, the method comprising:
performing first radio communication using first profile data of a first Subscriber Identify Module (SIM), and performing second radio communication using second profile data of a second SIM;
causing a screen of the communication apparatus to display a first indicator of a communication state of the first radio communication under an operational condition in which the first radio communication is active; and
causing the screen to display a second indicator of a communication state of the second radio communication under another condition that the second radio communication is active.
   (25)

A communication apparatus having a display unit, the communication apparatus comprising:
a communication control unit that executes simultaneous communications that simultaneously use a plurality of data communications including first data communication using a first profile associated with a first SIM and second data communication using a second profile associated with a second SIM; and
a display control unit that displays an indication related to the simultaneous communications on the display unit.
   (26)

The communication apparatus according to (25), wherein
the display control unit displays, on the display unit, as an indication related to the simultaneous communications, an indication that makes it possible to distinguish whether the simultaneous communications are being executed or non-simultaneous communications using any of the plurality of data communications are being executed.
   (27)

The communication apparatus according to (26), wherein
the display control unit displays an indication related to the simultaneous communications in association with an indication related to the first data communication and an indication related to the second data communication.
   (28)

The communication apparatus according to (27), wherein
an indication related to the first data communication is a first radio field intensity indication related to the first data communication, and
an indication related to the second data communication is a second radio field intensity indication related to the second data communications.
   (29)

The communication apparatus according to any one of (26) to (28), wherein
an indication related to the simultaneous communications is an indication that makes it possible to distinguish a communication type of data communication.
   (30)

The communication apparatus according to (29), wherein
the communication type comprises a communication direction.
   (31)

The communication apparatus according to any one of (25) to (30), wherein
the display control unit displays, on the display unit, as an indication related to the simultaneous communications, a first indication indicating use of the first data communication by a first application and a second indication indicating use of the second data communication by one or a plurality of other applications.
   (32)

The communication apparatus according to (31), wherein
the display control unit displays the first indication in association with an indication related to the first data communication and the second indication in association with an indication related to the second data communication.
   (33)

The communication apparatus according to (32), wherein
an indication related to the first data communication is a first radio field intensity indication related to the first data communication, and
an indication related to the second data communication is a second radio field intensity indication related to the second data communication.
   (34)

The communication apparatus according to any one of (25) to (33), wherein
the display control unit displays, as an indication related to the simultaneous communications, a first user interface capable of associating an application with two or more data communications among the plurality of data communications.
   (35)

The communication apparatus according to (34), wherein
the display control unit displays the first user interface when downloading or uploading related to the application is executed.
   (36)

The communication apparatus according to (35), wherein
the display control unit displays the first user interface in a case where data size of the downloading or the uploading is larger than a predetermined threshold.
   (37)

The communication apparatus according to (35) or (36), comprising
a setting unit that sets data communication selected by using the first user interface as a default setting when the application performs data communications.
   (38)

The communication apparatus according to any one of (34) to (37), wherein
the display control unit displays the first user interface in a case where a predetermined operation is performed on an icon of the application displayed on the display unit.
   (39)

The communication apparatus according to any one of (34) to (38), wherein
the display control unit displays the first user interface when a plurality of windows each displaying an application is displayed on the display unit.
   (40)

The communication apparatus according to (39), wherein
the display control unit displays an indication indicating data communication used by an application in each of the plurality of windows.
   (41)

The communication apparatus according to any one of (25) to (40), wherein
the display control unit displays, as an indication related to the simultaneous communications, a second user interface capable of associating time with two or more data communications among the plurality of data communications.
   (42)

The communication apparatus according to (41), wherein
the second user interface is an interface for inputting a schedule.
   (43)

An information processing method executed by a communication apparatus having a display unit, the method comprising:
executing simultaneous communications that simultaneously use a plurality of data communications including first data communication using a first profile associated with a first SIM and second data communication using a second profile associated with a second SIM; and
displaying an indication related to the simultaneous communications on the display unit.
   (44)

A program causing
a computer controlling a communication apparatus having a display unit to function as:
a communication control unit that executes simultaneous communications that simultaneously use a plurality of data communications including first data communication using a first profile associated with a first SIM and second data communication using a second profile associated with a second SIM; and
a display control unit that displays an indication related to the simultaneous communications on the display unit.

### REFERENCE SIGNS LIST

1 Communication system
10 Server
20 Terminal apparatus
11, 21 Communication unit
12, 22 Storage unit
13, 23 Control unit
24 Input unit
25 Output unit
231 Communication control unit
232 Display control unit
233 Setting unit
251 Display unit
A1, A2 Radio field intensity indication
B1, C1 to C3 Communication icon
D1, D2, P1, P2 Icon
E1, E2 SIM Indicator
F1, F2 Display
G1 Area
MW1, MW2, W1 to W7 Window
V1 Upper area
V2 Central area
V3 Lower area

1. A communication apparatus comprising:
circuitry configured to
perform first radio communication using first profile data of a first Subscriber Identify Module (SIM), and perform second radio communication using second profile data of a second SIM,
cause a screen of the communication apparatus to display a first indicator of a communication state of the first radio communication under an operational condition in which the first radio communication is active, and
cause the screen to display a second indicator of a communication state of the second radio communication under another condition that the second radio communication is active.

2. The communication apparatus of claim 1, further comprising:
the screen, wherein the circuitry is configured to cause the first indicator and the second indicator to be displayed on a portion of the screen that is different than a window in which an application is displayed.

3. The communication apparatus of claim 1, wherein the first indicator includes a field intensity indicator of the first radio communication, and the second indicator includes a field intensity indicator of the second radio communication.

4. The communication apparatus of claim 3, wherein the circuitry is also configured to display a communication icon on the screen in association with at least one of the first indicator and the second indicator, the communication icon includes displayed information regarding an activation status of at least one of the first radio communication and the second radio communication.

5. The communication apparatus of claim 1, wherein the circuitry is configured to simultaneously perform data communications according to the first profile data and also perform data communications according to the second profile data.

6. The communication apparatus of claim 1, wherein the circuitry is also configured to display on the screen at least one communication icon that indicates a direction of communication in association with at least one of the first indicator and the second indicator.

7. The communication apparatus of claim 1, wherein the circuitry is also configured to cause the screen to display at least one communication icon in association with at least one of the first indicator and the second indicator, the communication icon indicates a type of radio access technology used with at least one of the first radio communication and the second radio communication.

8. The communication apparatus of claim 6, wherein the at least one communication icon includes
a first communication icon that is displayed adjacent to the first indicator, and
a second communication icon that is displayed adjacent to the second indicator.

9. The communication apparatus of claim 8, wherein the first communication icon is displayed in a highlighted state under a condition the first radio communication is active for data communication, the highlighted state being highlighted with respect to a displayed state of the second communication icon under a condition the second radio communication is active but not used for data communication.

10. The communication apparatus of claim 1, wherein the circuitry is also configured to cause the screen to display a first application icon adjacent to the first indicator, and a second application icon adjacent to the second indicator, the first application icon being an indication of a first application that is being run on the communication apparatus and that uses data communications via the first radio communication according to the first profile data, and the second application icon being an indication of a second application that is being run on the communication apparatus and that uses data communications via the second radio communication according to the second profile data.

11. The communication apparatus of claim 1, wherein the circuitry is also configured to display on the screen a first application icon adjacent to a first SIM indictor, and a second application icon adjacent to the second SIM indicator.

12. The communication apparatus of claim 1, wherein
the circuitry is configured to cause the first radio communication to support data communications for a first application that is run on the communication apparatus, and
cause the second radio communication to support data communications for a second application that is run on the communication apparatus.

13. The communication apparatus of claim 1,
wherein the circuitry is configured to display a plurality of user-selectable SIM indicators on the screen,
a first SIM indicator of the user-selectable SIM indicators is for the first SIM and a second SIM indicator of the user-selectable SIM indicators is for the second SIM,
in response to an actuation of a first user-selectable SIM indicator of the user-selectable SIM indicators, the circuitry is configured to cause the first radio communication to support data communications for at least one application, and
in response to an actuation of a second user-selectable SIM indicator of the user-selectable SIM indicators, the circuitry is configured to cause the second radio communication to support data communications for the at least one application.

14. The communication apparatus of claim 13, wherein the circuitry is configured to display on the screen the plurality of user-selectable SIM indicators in response to execution of downloading or uploading related to the at least one application.

15. The communication apparatus of claim 14, wherein the circuitry is configured to display the plurality of user-selectable SIM indicators in response to data size of the downloading or the uploading being larger than a predetermined threshold.

16. The communication apparatus of claim 13, wherein the circuitry is configured to display on the screen the plurality of user-selectable SIM indicators in response to an operation for an icon of the at least one application displayed on the screen.

17. The communication apparatus of claim 1, further comprising:
the screen, the screen being a touchscreen having a first window on which the first application being run on the communication apparatus is active, and a second window on which the second application being run on the communication apparatus is active, wherein
the circuitry is configured to
display a plurality of user-selectable SIM indicators in the first window, the plurality of user-selectable SIM indicators including a first user-selectable SIM indicator for the first SIM and a second user-selectable SIM indicator for the second SIM,
in response to an actuation of the first user-selectable SIM indicator in the first window, cause the first radio communication to support data communications for the first application that is active on the first window,
display the plurality of user-selectable SIM indicators in the second window,
in response to an actuation of the first user-selectable SIM indicator in the second window, cause the first radio communication to support data communications for the second application that is active on the second window, and
in response to an actuation of the second user-selectable SIM indicator in the second window, cause the second radio communication to support data communications for the second application that is active on the second window.

18. The communication apparatus of claim 1, further comprising:
the screen, the screen being a touchscreen, wherein the circuitry is configured to
display a set of user-selectable options that include a user-selectable option for one of the first SIM or the second SIM, each of the user-selectable options being one of a time zone, or an event.

19. An information processing method for a communication apparatus comprising:
performing first radio communication using first profile data of a first Subscriber Identify Module (SIM), and performing second radio communication using second profile data of a second SIM;
causing a screen of the communication apparatus to display a first indicator of a communication state of the first radio communication under an operational condition in which the first radio communication is active; and
causing the screen to display a second indicator of a communication state of the second radio communication under another condition that the second radio communication is active.

20. A non-transitory computer readable memory having computer readable instructions that are stored therein that upon execution by processing circuitry configure the processing circuitry to perform a method in a communication apparatus, the method comprising:
performing first radio communication using first profile data of a first Subscriber Identify Module (SIM), and performing second radio communication using second profile data of a second SIM;
causing a screen of the communication apparatus to display a first indicator of a communication state of the first radio communication under an operational condition in which the first radio communication is active; and
causing the screen to display a second indicator of a communication state of the second radio communication under another condition that the second radio communication is active.
